(19) United States
(12) Patent Application Publication
(10) Pub. No.: US 2004/0196117 A1
(43) Pub. Date: Oct. 7, 2004

(54) Method for the manufacture of an actuator device an actuator device produced thereby

(75) Inventors: Albert Kiessling, Weil der Stadt (DE); Thomas Reininger, Wernau (DE)

Correspondence Address: HOFFMANN & BARON, LLP, 6900 JERICHO TURNPIKE, SYOSSET, NY, 11791, US

(73) Assignee: FESTO AG & CO.

(21) Appl. No.: 10/802,892

(22) Filed: Mar. 17, 2004

(30) Foreign Application Priority Data
Apr. 5, 2003 (EP) 03007475.1

(51) Int. Cl. H01Q 13/00; H01P 1/18

(52) U.S. Cl. 333/157; 29/600; 29/840; 29/890.09

(57) ABSTRACT

A method for the production of an actuator device and an actuator device. The actuator device comprises a more particularly fluid power driven actuator able to move in a housing and a position detecting means, in the case of which by means of an exciting current from a current source an actuator in a magnetostrictive wave guide a concentric magnetic field may be produced, such wave guide being arranged along a working stroke of the actuator, such magnetic field being able to be so influenced by a position indicating magnet arranged on the actuator that an ultrasonic wave deforming the wave guide is obtained. A measurement means is present for the position of the position indicating magnet on the basis of measurement of the transit time of the ultrasonic wave. The wave guide and a return guide for the reflux of the exciting current to the current source are made available on an assembly stage in a predetermined amount suitable for measurement paths of different length, at which the actuator is assembled. At an assembly stage the wave guide is cut to a length suitable for the measurement path of the respective actuator device to be produced and is electrically connected with the return guide.

### BACKGROUND OF THE INVENTION

The invention relates to a method for the manufacture of a more particularly fluid power driven actuator device comprising an actuator movingly arranged in a housing, and a position detecting means, in the case of which by means of an exciting current available from a current source a concentric magnetic field may be produced in a magnetostrictive wave guide for arrangement on a measurement path along a working stroke of the actuator, such magnetic field being able to be so influenced by a position indicating magnet arranged on the actuator that an ultrasonic wave is produced deforming the wave guide, and in the case of which a measurement means is provided for the position of the position indicating magnet on the basis of measurement of the transit time of the ultrasonic wave.

### THE PRIOR ART

Such an actuator device is for example disclosed in the patent publication WO 93/15378. The position detecting means is modularly designed so that it may be introduced in the otherwise completed actuator device. The actuator device is for example a fluid power, pneumatic or electromagnetic linear drive. For different measurement path lengths, which correlate to the working stroke of the actuator, as for example a pneumatically drive piston, differently designed position detecting modules are necessary. The expenses of stockholding are substantial, and flexibility of production is poor.

Known actuator devices with the modular position detecting means are complex and expensive.

### SHORT SUMMARY OF THE INVENTION

Accordingly one object of the present invention is to provide for simplification and economy as regards a method for the manufacture of an actuator device of the type initially mentioned and furthermore an actuator device which is simple to produce.

In order to achieve these and/or other objects appearing from the present specification, claims and drawings, in a method of the type initially described the wave guide and a return guide for the reflux of the exciting current to the current source are made available to a predetermined suitable degree for different lengths of measurement path at an assembly stage, at which the actuator device is mounted and the wave guide is cut to a length on the assembly stage suitable for the measurement path of the respective actuator device to be produced and is connected electrically with the return guide.

In the case of the actuator device for attaining the object of the invention there is the provision that the wave guide and/or the return guide are at least partly directly arranged without a separate guard tube in a groove extending along the working stroke of the actuator and/or a hole in the housing of the actuator device. The actuator device is for instance a fluid power drive, for example a pneumatic drive, and/or electromagnetic linear drive or a rotary drive.

In the method differently dimensioned actuator devices, as for example fluid power linear or rotary drives, may be provided with position detecting means. The position detecting means is suitable for different actuator devices. By suitably cutting the wave guide and/or the return guide to the necessary length there is an adaptation to the respective path of measurement, normally the working stroke of the actuator, on the assembly stage, for example in the building, in which the actuator devices are mounted. However, it is particularly preferred for the for the assembly stage to be a manufacturing station, at which the actuator device undergoes initial assembly or, respectively, final assembly. The actuator device is for instance prefabricated until only the position detecting means remains to be added. The position detecting means is supplied to the assembly station. There the wave guide and possibly also the return guide, is cut to length and joined to the return guide and then arranged on the actuator device.

In the case of the actuator device in accordance with the invention it is possible to dispense with a separate guard tube, in which the wave guide may be arranged for protection against harmful effects from the surroundings.

Advantageous developments of the invention are defined in the claims.

It is convenient for the ends to be connected of the return guide and of the wave guide to be open when they are made available at the assembly stage. The ends opposite to the ends to be connected of the return guide and/or of the wave guide are best premounted on the measurement means. They may however be premounted as well on the current source or on the component constituting current source and the measurement means.

For the electrical and/or mechanical connection of the wave guide with the return guide welding or soldering is for example suitable. The two guides may be connected together, for example with a bushing, such as a crimp sleeve. Such a sleeve then conveniently constitutes an oscillation absorber for the ultrasonic wave. By the use of a bushing undesired reflections on the wave guide are prevented.

It is convenient to arrange an oscillation absorber means for the damping of an ultrasonic wave at an end of the wave guide remote from the measurement means. The oscillation absorber means may also be referred to as mechanical sump. In any case the oscillation absorber means prevents reflections of ultrasonic waves on the wave guide. The oscillation absorber means may for example be constituted by a piece of shrink hose, by a drop of adhesive or by the above mentioned bushing for the electrical connection of the wave guide and the return guide, or by like means. Furthermore potting the end of the wave guide, which is to be damped as regards oscillation, is possible. The end to be damped is for example roughened in order to ensure an optimum mechanical coupling with the oscillation absorbing means, for example the bushing. It is possible as well for the oscillation absorbing means to be at least partly arranged in a region of the wave guide, which is to the fore of the contact region with the return guide.

It is convenient for the wave guide to be arranged on the housing of the actuator device in a manner allowing vibrations so that the ultrasonic wave may propagate with the least impediment.

The wave guide and/or the return guide are best at least partly arranged in a groove extending along the working stroke of the actuator and/or a hole in the housing. Such a hole or groove extends for example adjacent to a cylinder chamber, in which a pneumatically drive piston is able to run in the longitudinal direction. The wave guide and/or the return guide are preferably arranged in a guard tube. Such guard tube is best arranged along the working stroke of the actuator on the housing of the actuator device.

The groove, the hole or, respectively, the guard tube are preferably filled with a vibrationally elastic potting composition so that the ultrasonic wave may propagate in the wave guide.

The actuator device will conveniently comprise a signaling means for signals with respect to the separate positions of the position indicating magnet. The signaling means passes on position data in the form of a plurality of separate position sensors or position switches, which are arranged along the working stroke of the actuator on the housing of the actuator device. The measurement means, the current source, respectively, the signaling means are preferably arranged on the housing of the actuator device and more especially on a housing cover.

It is to be preferred for the wave guide and/or return guide to be extremely exactly trimmed to length and arranged on the housing of the actuator device so that the values or readings of the measurement means are as accurate as possible. Any manufacturing inaccuracies are preferably compensated for by calibration of the measurement means to a length of the actuator device corresponding to the length of the working stroke. The measurement means accordingly yields extremely exact readings or values.

The position indicating magnet is preferably magnetized athwart the working stroke. However a case frequently occurs in which the position indicating magnet must be magnetized in the direction of the working stroke. In conjunction with the invention it has been determined that with such position indicating magnets as well position data may be found, which permit regulation of the actuator device. In any case the accuracy of measurement is sufficient for determination of discrete position values.

The wave guide is preferably constituted by a wire. It is however also possible for the wave guide to be constituted by a hollow guide.

Preferably an output means is provided for the output of continuous position data on the position indicating magnet to the actuator device. For instance, the position data may have a linear characteristic correlated to the position of the actuator traveled to. On the basis of the continuous position data a regulation of the actuator device is possible. It is convenient for such a regulation device to be present in the actuator device.

Further advantageous developments and convenient forms of the invention will be understood from the following detailed descriptive disclosure of embodiments thereof in conjunction with the accompanying drawings.

### LIST OF THE SEVERAL VIEWS OF THE FIGURES

FIG. 1 shows a diagrammatic representation of the method of the invention for the production of actuator devices on an assembly stage or bench.

FIG. 2 shows a cross sectional view of an actuator device in accordance with the invention.

FIG. 3 is a diagrammatic representation of the manner of functioning of a position detecting means of the actuator device in accordance with FIG. 2.

FIG. 4 shows continuous progressing position data as produced by the position detecting means in FIG. 3.

FIG. 5 shows digital position data produced in accordance with FIG. 4 from the continuous values produced in accordance with FIG. 4.

FIG. 6 shows an actuator with position indicating magnet magnetized along the working stroke and furthermore a flux conducting member.

FIG. 7 shows an actuator with a position indicating magnet magnetized athwart the working stroke.

FIG. 8 is a cross sectional view of a contact terminal arrangement for the connection of a wave guide and a return guide of a position detecting means manufactured in accordance with the invention.

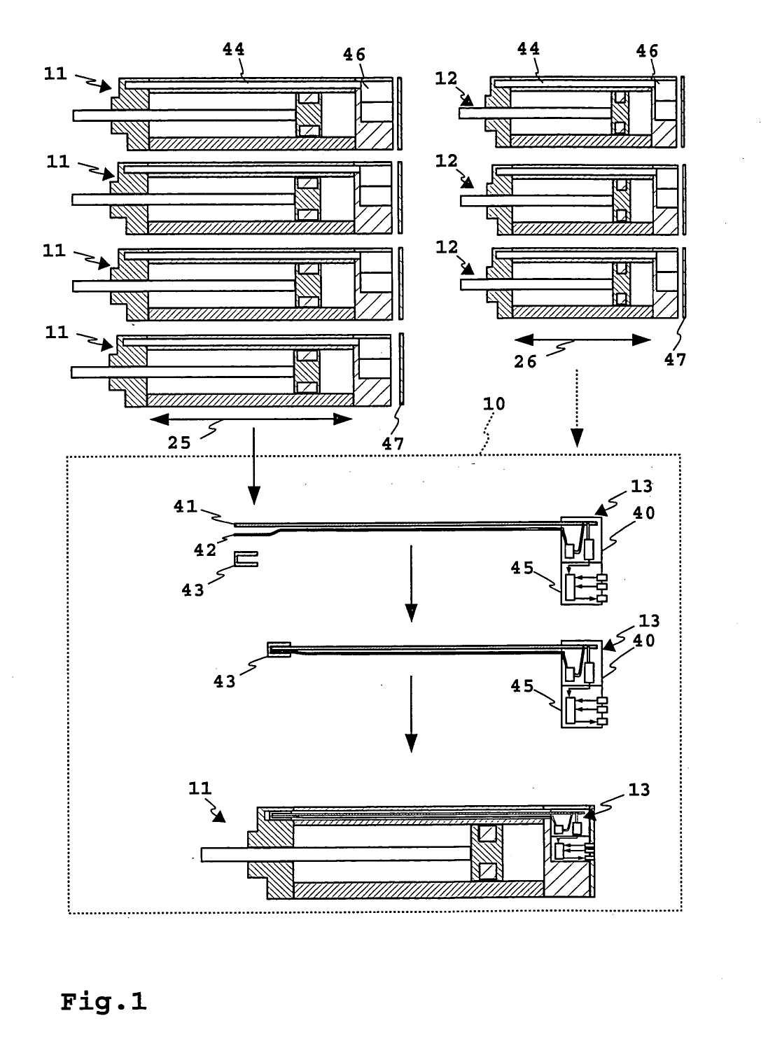

### DETAILED ACCOUNT OF WORKING EMBODIMENTS OF THE INVENTION.

On an assembly stage 10, for example of an assembly station, pneumatic cylinders 11 and 12, that is to say fluid power actuator devices, are assembled. On the assembly stage 10 in principle electromagnetic actuator devices may be assembled as well. The pneumatic cylinders 11 and 12 are linear drives. However rotary drives could be fitted with position detecting means 13 on the assembly stage 19 as well in the manner to be described in accordance with the invention.

The cylinders 11 and 12 in principle have the same design. They differ only as regards the working strokes of their respective actuators. In what follows identical or functionally identical components of the cylinders 11 and 12 will be given the same reference numerals.

In a housing 14 with an elongated housing space 15 an actuator 16 constituted by a piston runs axially. On the actuator 16 a transmission element 17 is secured which is rod-like in the working example, which extends through the housing space 15 in the longitudinal direction coaxially. The transmission element 17 extends through an end wall 18 of the housing. The transmission element 17 constitutes, for example, a power output member.

The actuator 16 divides the housing space 15 into working spaces 19 and 20 which correspond to fluid ducts 21 and 22 in the end wall 18 and respectively on an end wall 23. The end wall 23 is arranged on the side, opposite to the end wall 18, of the housing space 15 and seals off same at the end. The end wall 18 can also be termed an end plate and the end wall 23 as a terminating plate or cover. Pressure medium, as for instance compressed air, can flow through the ducts 21 and 22 into the working spaces 19 and 20 or flow from them, the actuator 16 being reciprocated in the direction of a longitudinal axis 24 of the housing 14. The inner outline of the housing space 15 is for example circular, rectangular or has some other suitable cross section. The cylinders 11 and 12 could in principle also be piston rodless.

In the case of the cylinder 11 the actuator 16 is able to be moved along its working stroke 25 and in the case of cylinder 12 the working stroke 26 moved along is shorter along the longitudinal axis 24.

For the detection of the respective position of the actuators 16 on the working strokes 24 and 25 there is a position detecting means generally referenced 13, the principle of its operation being indicated more particularly in FIG. 3. The measured distances or paths monitored by the position detecting means correspond to the working strokes 24 and 25.

With the aid of a current supply or source 27 an exciting current 28, for example a pulsed one, is produced. The exciting current 28 flows from the current source 27 by way of a magnetostrictive wave guide 29 and from its end 41, on which the wave guide 29 is connected at a connection point 37 with a return guide 30, via the return guide back to the current source 27. The wave guide 29 is for example ferromagnetic. The wave guide 29 is arranged on the housing 14 along the working strokes 25 and 26 of the actuators 16.

Owing to the exciting current 28 a circular magnetic field 31 is produced in the wave guide 29. A magnetic field 33 of a position indicating magnet 32, which is arranged on the actuator 16, influences the magnetic field 31 in the sense of interfering with it. In accordance with the Wiedemann effect there is then an elastic, torsional deformation of the wave guide 29 so that ultrasonic waves 34 and 35 are produced. The ultrasonic waves 34 and 35 are structure-borne ultrasonic waves, which are propagated from their origin, the position of the magnet 32 toward the two ends of the wave guide 29. The ultrasonic wave 35 is absorbed by an oscillation absorbing means 36, which is arranged near the end 41 of the wave guide 29. The ultrasonic wave 34 on the contrary is propagated as far as the end 38, opposite to the end 41, of the wave guide 29. At the end 38 there is a measurement means 39 for the position of the position indicating magnet 32. The measurement means 39 comprises for example a magnetostrictive metal strip, an inductive detection coil and a permanent magnet. The measurement means 39 constitutes a sort of torsional pulse converter, which measures the transit time of the ultrasonic wave 34 from the point of origin, the position of the position indicating magnet 32, as far as the end 38. Here it is taken into account that the transit time of the exciting current pulse 28 from the current source 27 to the position indicating magnet 32 is owing to the speed of propagation of the current being equal to the speed of light, negligible as compared with the propagation speed of the ultrasonic wave 34. In any case on the basis of the transit time of the ultrasonic wave 34 the position of the position indicating magnet 32 and accordingly the position of the actuator 16 along the working strokes 25 and 26 may be found.

In the working embodiment the pneumatic cylinders 11 and 12 are substantially pre-fitted before reaching the assembly stage 10. In principle the cylinders 11 and 12 could however also be supplied to the assembly stage 10 in a less completely fitted state. In any case the cylinders 11 and 12 are provided with position detecting means 13 at the assembly stage 10.

The position detecting means 13 are able to be universally adapted to and arranged on the pneumatic cylinders 11, on different pneumatic cylinders (not illustrated) or on other types of actuators cylinders. The wave guide 29 and the return guide 30 are pre-fitted on a measurement module 40 of the position detecting means 13. The measurement module 40 comprises the current source 27 and furthermore the measurement means 39, and are connected in a suitable fashion with the wave guide 29 and with the return guide 30 electrically and/or mechanically. The ends 41 and 42, remote from the measurement module 40, of the wave guide 29 and of the return guide 30 are initially open on supply of the position detecting means 13 to the assembly stage 10. The two ends 41 and 42 are electrically connected together so that the exciting current 28 may flow from the wave guide 29 to the return guide 30. Furthermore the wave guide 29 and the return guide 30 are to be adapted (prior to assembly on the cylinders 11 and 12) to the different lengths of the working strokes 25 and 26 of the cylinders 11 and 12, that is to say to different lengths of measurement paths.

The guides 29 and 30 are firstly trimmed or cut to a suitable length, for example with the aid of a suitable cutting tool, a laser cutting means or the like. Then the two ends 41 and 42 are introduced into a bushing 43. The bushing 43 is squeezed, for example using a crimping pliers, so that the guides 29 and are reliably electrically connected together. In principle the two ends 41 and 42 could be joined together by soldering, welding or the like electrically. It is possible as well for the end 41 of the wave guide 29 to be roughened on all sides before introduction into the bushing 43 in order in this manner to obtain an mechanically improved force fit between the two components.

The cut lengths of the guides 29 and 30 and furthermore the bushing 43 are then introduced into a hole 44, which extends along the working strokes 25 and 26 in the housing 14 in the end wall 18. In the mounted state the bushing 43 abuts against the end wall 18 and is held by same. The bushing 43 acts as an oscillation absorbing means 36. Otherwise the wave guide 29 is able to oscillate in the hole 44 so that the ultrasonic waves 34 and 35 may be propagated in it. It is also possible for the hole 44 to be filled by a potting composition which is elastic as regards oscillations. Furthermore it is possible in principle for the hole to be filed with such a potting composition only adjacent to the end wall 18. Furthermore in principle a drop of adhesive or the like may be applied, preferably adjacent to the bushing 43, for damping oscillations.

To mount the measurement module 40 and furthermore a signaling module 45 on the end wall 23, the end plate of the cylinders 11 and 12, an accommodating space 46 is provided. The accommodating space 46 is shut off at the end by a cover 47.

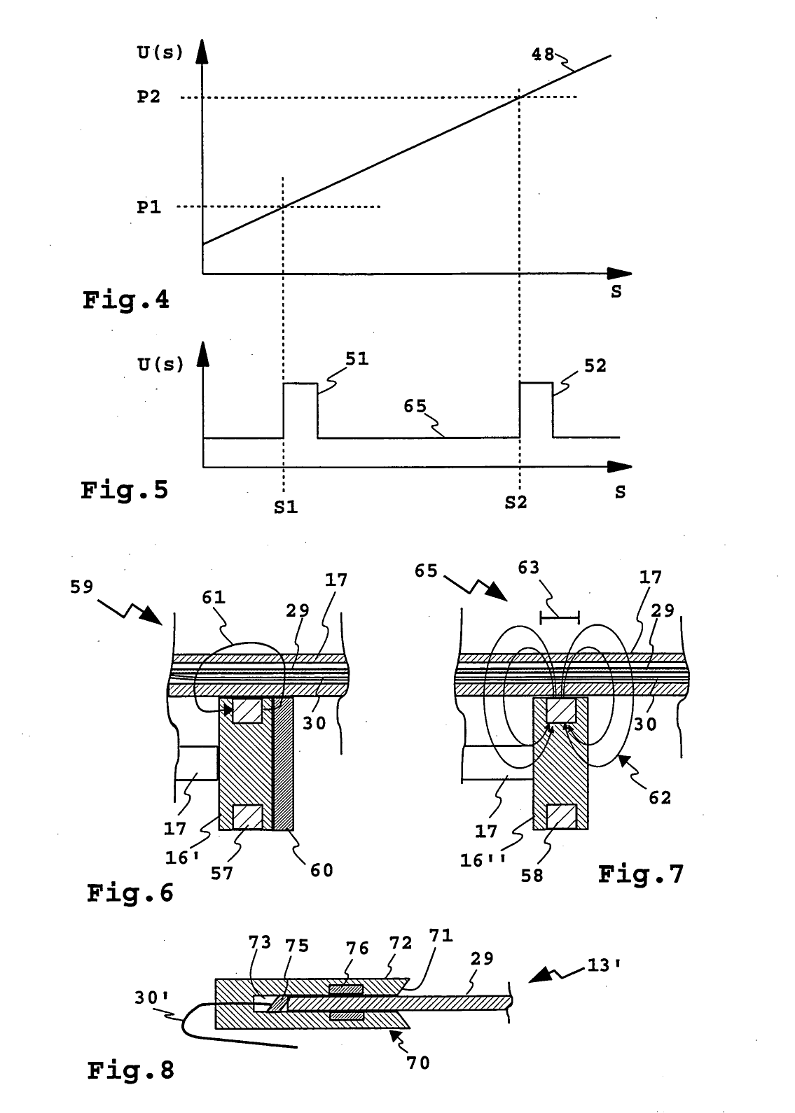

The measurement means 39 produces a continuous position signal 48 for the position of the position indicating magnet 32 and accordingly the position of the actuator 16. The position signal 48 has, for example, a linear characteristic, as represented in FIG. 4. The measurement means 39 is calibrated in accordance with the respective length of the wave guide 30 which is correlated with the working strokes 25 and 26 so that the position signal 48 has the ideal characteristic illustrated in FIG. 4. The position signal 48 may for example be taken from contact means 49, as for example a bushing as a measurement point, as an analog position signal. It is however also possible for the measurement means 39 to be able to be coupled with, for example, a field bus, by way of which messages containing position data may be transmitted, which are extracted from the position signal 48.

The measurement module 40 and the signaling module 45 are electrically connected with one another. The measurement module 40 transmits the position signal 48 to the signaling module 45. The signaling module 45 has a teach function. In the case of the signaling module 45 using key switches 50 or other input means, threshold values P1 and P2 of the position signal 48 may be defined or set at positions S1 and S2 along the working strokes 24 and 25, at which the signaling module 45 provides digital position data 51 and 52, as for example output pulses. An evaluating means 64 of the signaling module 44 analyses the position signal 48 in accordance with the threshold values P1 and P2 set at the key switches 50 and generates a digital output signal 53 which contains the position data 51 and 52. The digital output signal 53 is available at a bushing 66 or some other electrical and/or optical contact means. Accordingly the signaling module 45 provides a functionality which is familiar in, for example, the cylinder switch art. Such cylinder switches can for example be individual sensor switches such as reed switches, which are arranged on the outside of the housing 14 or on some other housing of a drive and are able to be activated by the position indicating magnet 32. It will be clear that in addition to the position detecting means 13 other cylinder switches may be arranged on the housing 14, for example for switching higher voltages of for example 220 volts, or the like.

When the actuator 16 and accordingly also position indicating magnet 32 moves past the positions S1 and S2 along the working stroke 25, and in the case of the cylinder 12, along working stroke 26, the signaling module 45 issues the digital output signal 53 indicated in FIG. 5. In the case of the output signal 53 the position data 51 and 53 are for example current or voltage pulses with a predetermined duration. The position signal 48 and the position data 51 and 52 are for example produced as voltage values U(s) dependent on the displacement S occurring along the working strokes 25 and 26

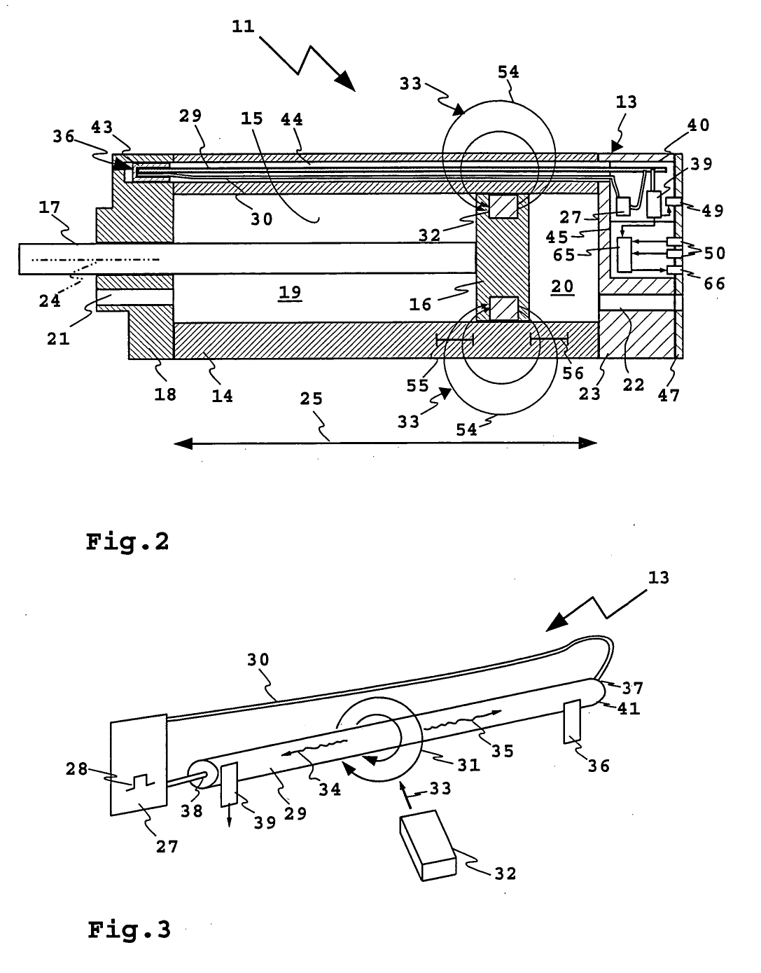

The position indicating magnet 32 is an annular magnet, which is arranged around the periphery of the actuator 16. The position indicating magnet 32 (FIG. 2) has a form of magnetization frequently employed in pneumatic cylinders for their position indicating magnets in the case of which the magnetic force lines essentially emerge along the working stroke of the actuator, for example in the direction of the longitudinal axis 24, from the position indicating magnet and enter it again. The course 54 of the lines of force of the magnetic field 33 is indicated in FIG. 2. The lines of force 54 penetrate the housing 14 in regions 55 and 56 and accordingly furthermore the wave guide 29 in a radial direction, something leading to two mutually independent consecutive ultrasonic waves extending in the direction of, or toward, the measurement means 39, like the ultrasonic wave 34. The two regions 55 and 56 are spaced part in the longitudinal movement direction of the actuator 16. In connection with the invention it has been recognized that nevertheless a position signal, which may be obtained with the quality of the position signal 48, is also suitable for regulation of the position of the pneumatic cylinder 11. If necessary the measurement means 39 may be so tailored that it filters the received ultrasonic waves. For instance, the measurement means 39 could only evaluate the firstly received ultrasonic wave and from it derive the position of the actuator 16. It is possible as well for the measurement means to evaluate two consecutively received ultrasonic waves and to form a mean value from the determined transit times of the ultrasonic waves.

More exact signals may be obtained if the field lines of the magnetic field produced by a position indicating magnet cross over the wave guide at least in principle only in a narrowly delimited region in the longitudinal movement direction of the respective position indicating magnet. This is the case with the position indicating magnets 57 and 58 depicted in FIGS. 6 and 7.

FIG. 6 shows part of a pneumatic cylinder 59, which is essentially similar to the pneumatic cylinder 11. To the extent that components of the pneumatic cylinders 59 and 11 are the same, identical reference numerals will be utilized. At the end of the actuator 16′ of the cylinder 59 a flux conducting piece 60 is arranged, fashioned for example of a low-retentivity magnetic material, which radially redirect the magnetic force lines of the position indicating magnet 57 from the longitudinal direction, along which same emerge of the magnet 57, so that they radially move across the wave guide 29 in the vicinity of the magnet 57. In the working embodiment only one of the force lines 61 is indicated in the drawing.

The position indicating magnet 58 of a pneumatic cylinder 65 in accordance with FIG. 7 is radially magnetized. The position indicating magnet 58 is accordingly magnetized athwart the working stroke 25 so that the force lines 62 emerge in a radial direction from the position indicating magnet 58 and radially reenter it again. Consequently there is a relatively tightly limited region 63, in which the magnetic field of the position indicating magnet 58 reaches a maximum so that the position of the position indicating magnet 58 and consequently of an actuator 16″, on which the position indicating magnet 58 is arranged, may be exactly ascertained by the position detecting means 13.

In the case of the arrangement depicted in FIG. 8 the wave guide 29 is connected by means of a contact terminal arrangement 70 with a return guide 30′ of a position detecting means 13′, which is essentially the same as the position detecting means 13. The return guide 30′ is, unlike the return guide 30, not arranged in the hole 44, but is for example pre-fitted on the housing 14. The return guide 30′ may constitute an integral component of the housing 14.

The contact terminal arrangement 70 could for example be arranged on the end of the hole 44, approximately at the position of the bushing 43. Preferably the contact terminal arrangement 70 is arranged in the end wall 18 of the housing, for example in a housing cover. The wave guide 29 is trimmed to the correct length corresponding to the length of the working strokes 25 or 26. Then the wave guide 29 is inserted into the hole 44 until it is guided by a guide receiving opening 71, which may be conical, in the contact terminal arrangement 70. Owing to the guide receiving opening 71 the wave guide 29 is introduced into an accommodating space 73, which may be elongated, in a housing 72 of the contact terminal arrangement 70. The guide receiving opening 71 is arranged at the end of the housing 72 of the contact terminal arrangement 70, which for example consists of plastic. At end 74, opposite to the guide receiving opening 71, of the accommodating space 73 the wave guide 29 makes electrical contact with a contact terminal 75, same being connected electrically with the return guide 30′. Preferably the contact terminal arrangement 70 is for example self-locking owing to a suitable design of the contact terminal 75 so that when the wave guide 29 has once been inserted into the contact terminal arrangement 70 it is held by the latter and can not be withdrawn again from it without the application of force.

An oscillation absorbing means 76 is placed in front of the contact terminal 75 on the accommodating space 73. The oscillation absorbing means 76 is arranged between the guide receiving opening 71 and the contact terminal 75. The oscillation absorbing means 76 comprises for example an annular plastic part, which in the mounted state surrounds the wave guide 29, lies flat against it for example, and may serve as an acoustic absorber for the ultrasonic waves 35. The oscillation absorbing means 76 may contribute to the self-locking action of the contact terminal arrangement 70 or provide such self-locking action entirely by itself.

It will be clear that the contact terminal arrangement 70 may also be designed for receiving a return guide, which is to be cut to length like the return guide 30 and is to be mounted on the housing 14. For the return guide, which is initially loose, a guide receiving opening, a guide hole as it were, is to be provided on the contact terminal arrangement, into which the return guide is to be inserted in order to be connected with a contact terminal at the end of the accommodating space, such terminal being electrically connected with the contact terminal 75.

The oscillation absorbing means 76 could also be arranged outside the contact terminal arrangement 70, for example on the housing 14.

The return guide is preferably trained past the oscillation absorbing means in accordance with the invention, for example the oscillation absorbing means 76.

1. A method for the manufacture of a more particularly fluid power driven actuator device comprising an actuator movingly arranged in a housing, and a position detecting means, in the case of which by means of an exciting current available from a current source a concentric magnetic field may be produced in a magnetostrictive wave guide for arrangement on a measurement path along a working stroke of the actuator, such magnetic field being able to be so influenced by a position indicating magnet arranged on the actuator that an ultrasonic wave is produced deforming the wave guide, and in the case of which a measurement means is provided for the position of the position indicating magnet on the basis of measurement of the transit time of the ultrasonic wave, wherein the wave guide and a return guide for the reflux of the exciting current to the current source are made available to a predetermined suitable degree for different lengths of measurement path at an assembly stage, at which the actuator device is mounted and the wave guide is cut to a length on the assembly stage suitable for the measurement path of the respective actuator device to be produced and is connected electrically with the return guide.

2. The method as set forth in claim 1, wherein the act of arrangement on the assembly stage is such that the ends to be connected of the wave guide and of the return guide are open.

3. The method as set forth in claim 1, wherein the act of arrangement on the assembly stage is such that ends, which are opposite to the ends to be connected of the wave guide and of the return guide, of the wave guide and/or of the return guide are pre-fitted on the measurement means and/or the current source.

4. The method as set forth in claim 1, wherein the wave guide is welded and/or soldered and/or connected by means of a bushing and/or connected by a contact terminal arrangement, to the return guide.

5. The method as set forth in claim 4, wherein the bushing is designed in the form of an oscillation damper for the ultrasonic wave.

6. The method as set forth in claim 1, wherein an oscillation absorbing means is arranged at an end, which is remote from the measurement means, of the wave guide for damping the ultrasonic wave.

7. The method as set forth in claim 1, wherein for damping oscillations a drop of an adhesive composition is applied to the wave guide.

8. The method as set forth in claim 1, wherein the wave guide is arranged in such a manner allowing oscillations on the housing of the actuator device that the ultrasonic wave may be propagated.

9. The method as set forth in claim 1, wherein the wave guide and/or the return guide are at least partly arranged in a groove and/or a hole extending along the working stroke of the actuator, in the housing of the xactuator device.

10. The method as set forth in claim 1, wherein the wave guide and/or the return guide are arranged in a guard tube and wherein the guard tube is arranged along the working stroke of the actuator on the housing of the actuator device.

11. The method as set forth in claim 9, wherein the groove and/or the hole and/or the guard tube are filled with a composition which is elastic as regards the transmission of oscillations.

12. The method as set forth in claim 1, wherein the measurement means and/or the current source and/or a signaling means for discrete position data of the position indicating magnet are arranged on the actuator device and more especially on a housing cover of the actuator device.

13. The method as set forth in claim 1, wherein the measurement means is set by calibration to a length, corresponding to the length of the working stroke, of the wave guide.

14. An actuator device comprising an actuator movably arranged in a housing and adapted to be moved, more particularly by fluid power, and a position detecting means, in the case of which using an exciting current, provided by a current source, in a magnetostrictive wave guide, which is arranged along a working stroke of the actuator, a concentric magnetic field may be produced, such field being able to be so influenced that an ultrasonic wave is produced with a deformation of the wave guide and in the case of which a measurement means is present for the position of the position indicating magnet with the aid of measurement of the transit time of the ultrasonic wave, wherein the wave guide and/or the return guide are arranged at least one partly and directly without a separate guard tube in a groove and/or a hole, which extends along the working stroke of the actuator, in the housing of the actuator device.

15. The actuator device as set forth in claim 14, wherein the position indicating magnet is magnetized athwart the working stroke and/or the wave guide is constituted by a wire.

16. The actuator device as set forth in claim 14, wherein the wave guide is connected with the return guide by welding and/or by soldering and/or by means of a bushing.

17. The actuator device as set forth in claim 14, wherein the bushing constitutes a component of an oscillation absorbing means.

18. The actuator device as set forth in claim 14, comprising a signaling means for the supply of discrete position data respecting the position indicating magnet.

19. The actuator device as set forth in claim 14, comprising an output means for the output of substantially continuous position data with respect to the position indicating magnet.
